(19) United States
(12) Patent Application Publication
(10) Pub. No.: US 2026/0359085 A1
(43) Pub. Date: Nov. 12, 2026

(54) METHOD FOR GENERATING USER INTERFACE BY USING GENERATIVE ARTIFICIAL INTELLIGENCE AND ELECTRONIC DEVICE THEREFOR

(71) Applicant: Samsung Electronics Co., Ltd., Suwon-si (KR)

(72) Inventors: Donghee SUH, Suwon-si (KR); Doosuk KANG, Suwon-si (KR); Hyeongseok KIM, Suwon-si (KR); Sungkweon PARK, Suwon-si (KR); Kyeongjin JEON, Suwon-si (KR)

(21) Appl. No.: 19/721,888

(22) Filed: Jun. 26, 2026

Related U.S. Application Data
(63) Continuation of application No. PCT/KR2025/000318, filed on Jan. 7, 2025.

(30) Foreign Application Priority Data
Jan. 18, 2024 (KR) 10-2024-0007821
Mar. 4, 2024 (KR) 10-2024-0030898

(51) Int. Cl. G06F 9/451

(52) U.S. Cl. CPC G06F 9/453

(57) ABSTRACT

An electronic device is provided. The electronic device includes a display, memory, comprising one or more storage media, storing instructions, and at least one processor communicatively coupled to the display and the memory, wherein the instructions, when executed by the at least one processor individually or collectively, cause the electronic device to identify, using a first artificial intelligence (AI) model, at least one of one or more keywords or one or more intents from data comprising at least one of message information, schedule information, or input information, identify a recommended action based on at least one of the one or more keywords or the one or more intents, generate, using a second AI model, at least one prompt to generate a recommendation user interface (UI), acquire, by inputting the at least one prompt to a third generative AI model, the recommendation UI comprising guide information for the recommended action, and display the recommendation UI on the display.

### CROSS-REFERENCE TO RELATED APPLICATION(S)

This application is a continuation application, claiming priority under 35 U.S.C. § 365(c), of an International application No. PCT/KR2025/000318, filed on Jan. 7, 2025, which is based on and claims the benefit of a Korean patent application number 10-2024-0007821, filed on Jan. 18, 2024, in the Ministry of Intellectual Property (MOIP), and of a Korean patent application number 10-2024-0030898, filed on Mar. 4, 2024, in the Ministry of Intellectual Property (MOIP), the disclosure of each of which is incorporated by reference herein in its entirety.

### BACKGROUND

### 1. Field

The disclosure relates to a method of generating a user interface using generative artificial intelligence and an electronic device therefor.

### 2. Description of Related Art

Providing recommendation services through electronic devices is becoming widespread. An electronic device may recommend an application to a user based on a usage history of the user. For example, the electronic device may provide a recommended search term to the user based on a previous input record. The electronic device may recommend execution of an application that is different from an application currently being executed. For example, when a received message includes address information, the electronic device may recommend execution of a map application to search for a location corresponding to the address information. After terminating a message application being executed, the user may search for an icon to execute the map application. After the execution of the map application, the user may perform a search for the address to perform a search for the recommended location.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of generating a user interface using generative artificial intelligence and an electronic device therefor.

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, comprising one or more storage media, storing instructions, and at least one processor communicatively coupled to the display and the memory, wherein the instructions, when executed by the at least one processor individually or collectively, cause the electronic device to identify, using a first artificial intelligence (AI) model, at least one of one or more keywords or one or more intents from data comprising at least one of message information, schedule information, or input information, identify a recommended action based on at least one of the one or more keywords or the one or more intents, generate, using a second AI model, at least one prompt to generate a recommendation user interface (UI), acquire, by inputting the at least one prompt to a third generative AI model, the recommendation UI comprising guide information for the recommended action, and display the recommendation UI on the display.

In accordance with another aspect of the disclosure, a method for providing a recommendation UI of an electronic device is provided. The method includes identifying, using a first artificial intelligence (AI) model, at least one of one or more keywords or one or more intents from data comprising at least one of message information, schedule information, or input information, identifying a recommended action based on at least one of the one or more keywords or the one or more intents, generating, using a second AI model, at least one prompt to generate the recommendation UI, acquiring, by inputting the at least one prompt to a third generative AI model, the recommendation UI comprising guide information for the recommended action, and displaying the recommendation UI.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying, using a first artificial intelligence (AI) model, at least one of one or more keywords or one or more intents from data comprising at least one of message information, schedule information, or input information, identifying a recommended action based on at least one of the one or more keywords or the one or more intents, generating, using a second AI model, at least one prompt to generate a recommendation user interface (UI), acquiring, by inputting the at least one prompt to a third generative AI model, the recommendation UI comprising guide information for the recommended action, and displaying the recommendation UI.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a communication environment of an electronic device according to an embodiment of the disclosure;

FIG. 2 illustrates an artificial intelligence system according to an embodiment of the disclosure;

FIG. 3 illustrates modules of an electronic device according to an embodiment of the disclosure;

FIG. 4 illustrates a data management module of an electronic device according to an embodiment of the disclosure;

FIG. 5 illustrates a message screen of an electronic device according to an embodiment of the disclosure;

FIG. 6 illustrates a trigger management module of an electronic device according to an embodiment of the disclosure;

FIG. 7 illustrates a UI generation module of an electronic device according to an embodiment of the disclosure;

FIG. 8 is a flowchart of a method for generating a prompt by an electronic device according to an embodiment of the disclosure;

FIG. 9A illustrates a recommendation UI of an electronic device according to an embodiment of the disclosure;

FIG. 9B illustrates a recommendation UI of an electronic device according to an embodiment of the disclosure;

FIG. 9C illustrates a recommendation UI of an electronic device according to an embodiment of the disclosure;

FIG. 9D illustrates a recommendation UI of an electronic device according to an embodiment of the disclosure;

FIG. 10 illustrates additional information UIs of an electronic device according to an embodiment of the disclosure;

FIG. 11 illustrates a recommendation UI of an electronic device according to an embodiment of the disclosure;

FIG. 12 is a flowchart of a method for providing a UI by an electronic device according to an embodiment of the disclosure;

FIG. 13 is a flowchart of a method for acquiring a recommendation UI by an electronic device according to an embodiment of the disclosure; and

FIG. 14 is a block diagram illustrating an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

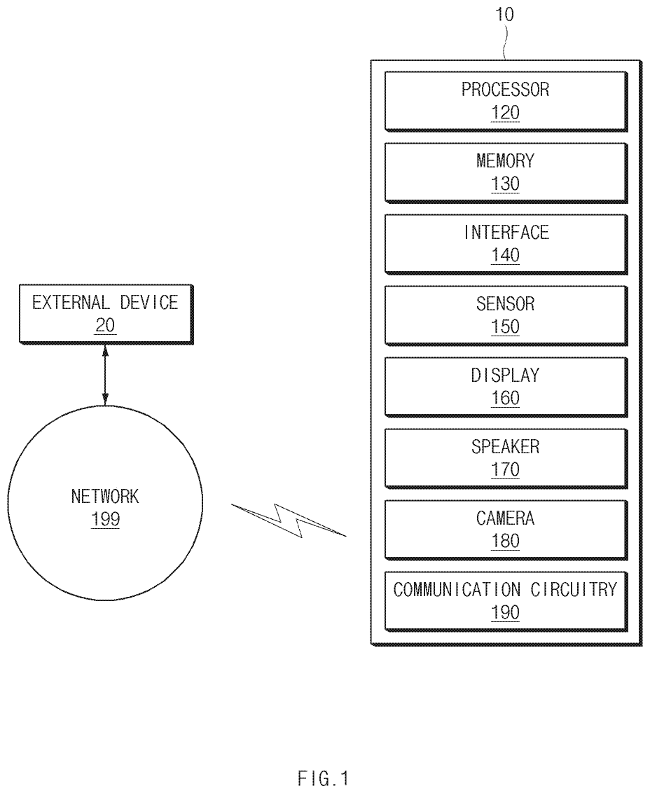

FIG. 1 illustrates a communication environment of an electronic device according to an embodiment of the disclosure.

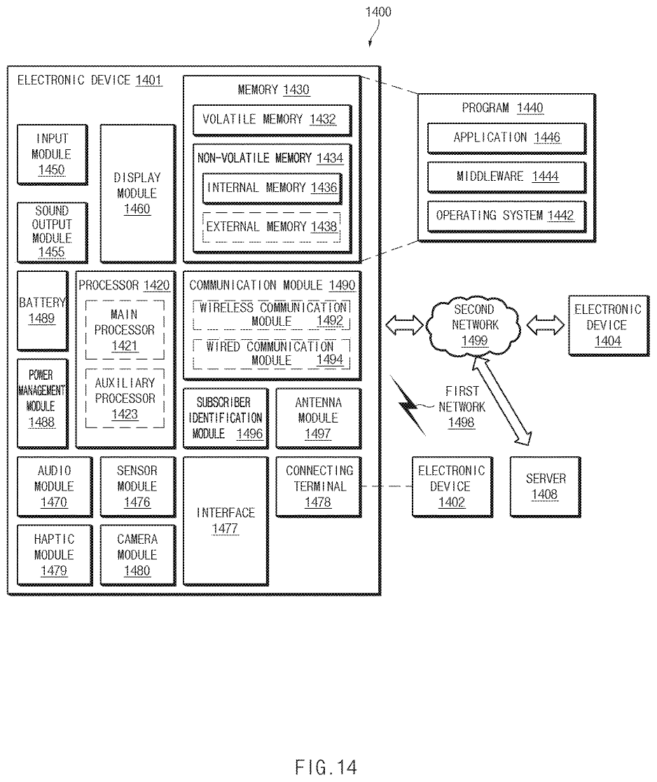

Referring to FIG. 1, according to an embodiment, an electronic device 10 may include a processor 120, memory 130, an interface 140, a sensor 150, a display 160, a speaker 170, a camera 180, and/or communication circuitry 190. For example, the electronic device 10 may include components similar to an electronic device 1401 to be described later with reference to FIG. 14. The electronic device 10 may be referred to as an arbitrary user device. For example, the electronic device 10 may include a bar-type mobile device, a foldable electronic device (e.g., an electronic device having a foldable display), a rollable electronic device (e.g., an electronic device having a rollable display), and/or an electronic device configured to provide extended reality (XR) (e.g., a head mounted display electronic device). For example, the processor 120 may correspond to a processor 1420 of FIG. 14. The memory 130 may correspond to memory 1430 of FIG. 14. The interface 140 may correspond to an interface 1477 of FIG. 14. The sensor 150 may correspond to a sensor module 1476 of FIG. 14. The display 160 may correspond to a display module 1460 of FIG. 14. The speaker 170 may correspond to an audio module 1470 of FIG. 14. The camera 180 may correspond to a camera module 1480 of FIG. 14. The communication circuitry 190 may correspond to a communication module 1490 of FIG. 14. The components of the electronic device 10 shown in FIG. 1 are exemplary, and the components of the electronic device 10 are not limited thereto. For example, the electronic device 10 may further include components not shown in FIG. 1. For example, the electronic device 10 may not include at least one of the components shown in FIG. 1.

The processor 120 may be electrically, operatively, or functionally connected to the memory 130, the interface 140, the sensor 150, the display 160, the speaker 170, the camera 180, and/or the communication circuitry 190. In various embodiments of the disclosure, when one component is “operatively” connected to another component, it may mean that the one component is connected so as to operate the other component. For example, the one component may operate the other component by transmitting a control signal directly or through another component to the other component. In various embodiments of the disclosure, when one component is “functionally” connected to another component, it may mean that the one component is connected so as to execute a function of the other component. For example, the one component may execute the function of the other component by transmitting a control signal directly or through another component to the other component.

The processor 120 may include at least one processor. The processor 120 may include one chip or one chipset. In the disclosure, the processor 120 may be referred to as a hardware component having an architecture based on at least one processing circuitry. For example, the processor 120 may be mounted on a board (e.g., a printed circuit board) positioned inside the electronic device 10 and may communicate with other components of the electronic device 10 through at least one conductive path formed on the board.

The memory 130 may store instructions. When individually or collectively executed by the processor 120, the instructions may cause the electronic device 10 to perform various operations. In various embodiments of the disclosure, operations of the electronic device 10 may be referred to as operations performed by the processor 120 through execution of instructions stored in the memory 130. The memory 130 may be referred to as a hardware component for storing data.

The interface 140 may include at least one hardware component for receiving a user input. For example, the interface 140 may include touch sensing circuitry for receiving a touch input. For example, the interface 140 may include at least one microphone for receiving a voice input. For example, the interface 140 may include any physical interface (e.g., a knob, jog shuttle, and/or button) for receiving a user input.

The sensor 150 may include at least one sensor for sensing information about a surrounding environment of the electronic device 10. For example, the sensor 150 may include an illuminance sensor, a proximity sensor, an accelerometer, a barometer, a temperature sensor, and/or a distance sensor.

The display 160 may be configured to display an image. In an example, the display 160 may include a plurality of displays. For example, the display 160 may include a left-eye display and a right-eye display. The display 160 may include a front display and a rear display. The display 160 may include at least one of a see-through display, a flexible display, a rollable display, a foldable display, and/or a rigid display.

The speaker 170 may be configured to output an audio signal. For example, the speaker 170 may be configured to convert an electrical signal into an acoustic signal and output the converted acoustic signal. The electronic device 10 may include a plurality of speakers. The speaker 170 may be configured to provide spatial sound, for example.

The camera 180 may include at least one camera module configured to acquire an image. For example, the processor 120 may acquire information about a surrounding environment of the electronic device (e.g., user context information) using the camera 180.

The communication circuitry 190 may include at least one circuit (e.g., a modem, a radio frequency integrated circuit, and/or a radio frequency processing circuit) configured to support communication between the electronic device 10 and the network 199 or another electronic device (e.g., the external device 20). The communication circuitry 190 may support wired communication and/or wireless communication. The communication circuitry 190 may support short-range wireless communication and/or long-range wireless communication.

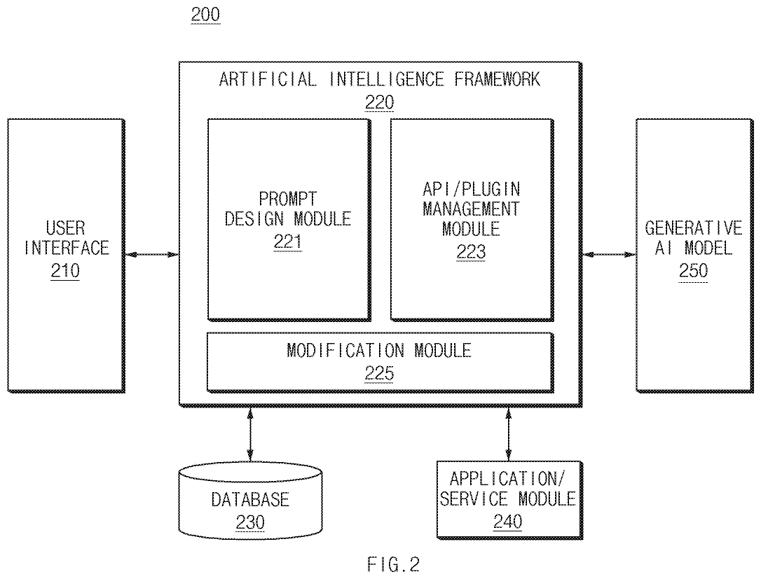

FIG. 2 illustrates an artificial intelligence system according to an embodiment of the disclosure.

Referring to FIGS. 1 and 2, according to an embodiment, the electronic device 10 may be configured to implement an artificial intelligence system 200. For example, the artificial intelligence system 200 may be implemented by executing, by the processor 120, instructions stored in the memory 130. Components within the artificial intelligence system 200 may be referred to as software modules (e.g., applications, programs, or threads). The components of the artificial intelligence system 200 illustrated in FIG. 2 are merely an example, and embodiments of the disclosure are not limited thereto. For example, at least some of the components of the artificial intelligence system 200 illustrated in FIG. 2 may be implemented in the external device 20 communicatively connected to the electronic device 10. The electronic device 10 may implement the artificial intelligence system 200 by exchanging data with the external device 20 using the communication circuitry 190.

For example, the artificial intelligence system 200 may include a user interface 210, an artificial intelligence framework 220, a database 230, an application/service module 240, and/or a generative AI model 250. As described above, the components of the artificial intelligence system 200 may be implemented by the electronic device 10, or at least some of the components may be implemented by the external device 20.

The user interface 210 may be referred to as a software interface between the artificial intelligence framework 220 and a user. For example, the user interface 210 may acquire an input (e.g., a user input and/or context information) using hardware components of the electronic device 10 (e.g., the interface 140, the sensor 150, and/or the camera 180). The user interface 210 may transmit the acquired input to the artificial intelligence framework 220. The user interface 210 may be configured to output output information acquired from the artificial intelligence framework 220.

In an example, the user interface 210 may be configured to process multi-modal inputs. For example, the user interface 210 may receive, as an input, at least one of text (e.g., natural language), an image, a sound, or a video. In an example, the input may include an input for the user interface (e.g., menu selection). For example, the user interface 210 may convert the acquired input into a form supported by the artificial intelligence framework 220 and transmit the converted input to the artificial intelligence framework 220.

In an example, the user interface 210 may transmit context information to the artificial intelligence framework 220. For example, the context information may be transmitted together with the input to the artificial intelligence framework 220. For example, the context information may include various additional information at a time when the input is received (e.g., information about a currently running application, location information, surrounding environment information acquired using the sensor 150, and/or information stored in the memory 130).

In an example, the user interface 210 may be configured to output a result of the artificial intelligence framework 220. For example, the user interface 210 may provide the result in the form of natural language, specified content, and/or a user-requested action. For example, the user interface 210 may be configured to output output information using the display 160 and/or the speaker 170. In an example, the user interface 210 may be configured to output the output information using visual information, auditory information, and/or tactile information.

According to an embodiment, the artificial intelligence framework 220 may be configured to receive a user input and coordinate and control respective components or modules required to perform a user intent based on the user input (e.g., a user query). For example, the artificial intelligence framework 220 may include a prompt design module 221, an application programming interface (API)/plugin management module 223, and/or a modification module 225.

For example, an input (e.g., user input and/or context information) received from the user interface 210 may be transmitted to the prompt design module 221. The prompt design module 221 may be used to generate a prompt suitable for input into a large language model (LLM) or a large multi-modal model (LMM). For example, the prompt design module 221 may include an artificial intelligence component using a machine learning algorithm or a neural network. For example, the prompt design module 221 may generate a prompt from the input using the artificial intelligence component.

For example, the LLM may refer to an artificial neural network-based language model trained on a large amount of text data through pre-training. The LLM may include significantly more parameters (e.g., 10 billion or more parameters) than conventional general language models. In an example, the LLM may use a transformer artificial neural network structure based on an attention mechanism.

The attention mechanism is a technique that enables an artificial intelligence model to focus attention on important portions within input data. The attention mechanism may be used to predict output data by predicting a degree to which a portion of time-series input data (e.g., input data such as voice or video or input data of some layers of a neural network) contributes to an intermediate or final output of the neural network. Although a recurrent neural network (RNN) structure that sequentially processes each element of a sequence may exhibit degraded prediction performance when there is information dependency across long time-series distances, the attention mechanism may consider such information dependency across long time-series distances by controlling a degree of weight concentration (e.g., attention) within a context of all or part of the input data.

For example, the transformer may be configured in an encoder-decoder structure. The encoder may process input data and output compressed information (e.g., contextual representation), and the decoder may process the compressed information and output output data in units of tokens. Each of the encoder and the decoder may include an independent attention network and may include a cross-attention network connecting the encoder and the decoder.

For example, LLM training may include pre-training and/or fine-tuning. Pre-training may be referred to as a process of training the LLM with general language knowledge using a large amount of text data. For example, pre-training may include self-supervised learning that predicts a next word using previous words in a text sequence. Fine-tuning may be referred to as a process of training the LLM to be suitable for a specific domain (e.g., chatbot, translation, summarization, or question and answer (Q&A)) or task. For example, the LLM may additionally undergo supervised learning (or adaptive learning) using a dataset suitable for a domain purpose based on a pre-trained model. The LLM may perform a task based on a prompt (e.g., a text input including natural language). For example, fine-tuning may be omitted from LLM training.

In order to improve performance of a task desired by a user, a prompt to be input to the LLM may be selected. In a manner such as in-context learning, zero-shot learning, and/or few-shot learning, examples of the task and/or a guide for performing the task may be additionally provided as the prompt.

The term “LLM” may refer to the language neural network model itself, but may also refer to a model of an LLM-based application (e.g., chatbot, translation, summarization, text classification, or sentence generation). For example, an LLM-based chatbot such as ChatGPT or an LLM-based translator may also be referred to as an “LLM.” Examples of publicly available LLMs include bidirectional encoder representations from transformer (BERT) and generative pre-trained transformer (GPT).

The term “LLM” may include an inference engine using an LLM neural network model. For example, “inputting an input prompt into an LLM” may mean “inputting the input prompt into an inference engine based on the LLM.” For example, an “output of the LLM for the input prompt” may mean output information of a final neural network layer of the LLM acquired when the input prompt is input into the inference engine based on the LLM.

The prompt design module 221 may be configured to generate a prompt based on the input and/or the database 230. For example, the database 230 may store user preference data, a prompt library, and/or prompt examples. For example, the prompt design module 221 may generate a prompt using information stored in the database 230. As described later, the prompt design module 221 may use information acquired using the API/plugin management module 223 to generate the prompt. The generated prompt may be transmitted to the generative AI model 250 (e.g., a large language model (LLM) or a large multi-modal model (LMM)).

The API/plugin management module 223 may be configured to exchange data with elements external to the artificial intelligence framework 220. For example, the API/plugin management module 223 may generate a communication channel with elements external to the artificial intelligence framework 220 (e.g., an operating system and/or an application) through an API. The API/plugin management module 223 may access various data sources through the generated channel and acquire data. Data acquired by the API/plugin management module 223 may be used by the prompt design module 221 for prompt generation. Data acquired by the API/plugin management module 223 may be used as an input to the generative AI model 250. In an example, when data (e.g., user input) is required in a process of generating a result of the artificial intelligence framework 220, the API/plugin management module 223 may acquire the data using an application and/or service of the application/service module 240.

In an example, the application/service module 240 may include at least one application and/or at least one service. For example, the at least one service may include a service of an operating system. An application and/or service of the application/service module 240 may communicate with the API/plugin management module 223 through an API or plugin. The API/plugin management module 223 may transmit, through the API or plugin, data instructing a specified operation to an application or service module of the application/service module 240.

According to an embodiment, the modification module 225 may finely tune a result output from the generative AI model 250. For example, the modification module 225 may perform filtering on content generated through the generative AI model 250. The modification module 225 may be configured to remove or filter biased content, harmful content, content having low relevance to a prompt, and/or hateful content from the output result. In an example, the modification module 225 may identify a relationship (e.g., correlation) between the output result of the generative AI model 250 and a user intent (e.g., an intent identified from a user input and/or context information). When the relationship between the output result and the user intent is low, the modification module 225 may perform an additional operation. For example, the modification module 225 may acquire an additional user input in order to obtain a result having a higher relationship. In order to prevent repetition of an additional procedure, the modification module 225 may generate a hint and provide the generated hint to the user.

According to an embodiment, the generative AI model 250 may be referred to as an artificial intelligence neural network that generates a new form of data (e.g., data including information not included in input information) from user input information. The generative AI model 250 may include a model for generating an image and/or a model for generating language. The model for generating an image may include, for example, a generative adversarial network (GAN), a variational auto encoder (VAE), and/or a diffusion-based generative model using a VAE and transformer structure. The model for generating language may include a model trained to output a statistically most appropriate output value based on an input value. For example, the model for generating language may include a model such as CHAT-GPT 3 or CHAT-GPT 4. The generative AI model 250 may include a large language model (LLM) or a large multi-modal model (LMM).

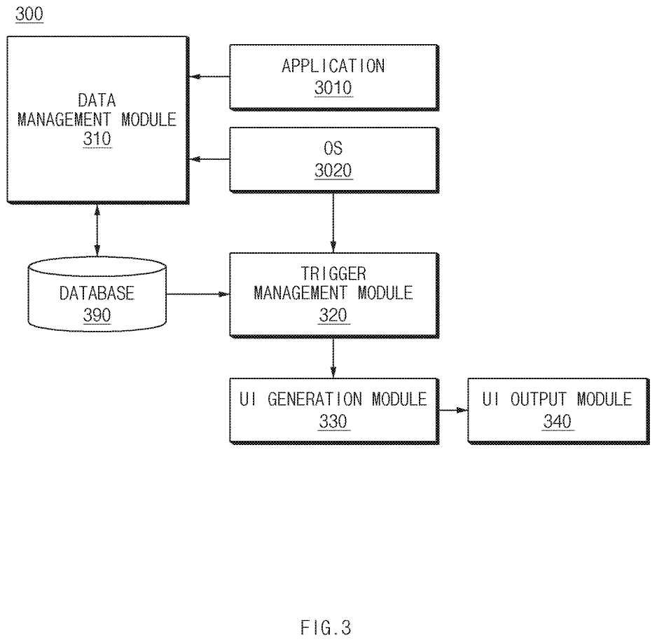

FIG. 3 illustrates modules of an electronic device according to an embodiment of the disclosure.

Referring to FIGS. 1 and 3, according to an embodiment, the electronic device 10 may be configured to implement a UI generation system 300. For example, the UI generation system 300 may be implemented by execution, by the processor 120, of instructions stored in the memory 130. Components within the UI generation system 300 may be referred to as software modules (e.g., applications, programs, or threads). The components of the UI generation system 300 illustrated in FIG. 3 are merely an example, and embodiments of the disclosure are not limited thereto. For example, at least some of the components of the UI generation system 300 illustrated in FIG. 3 may be implemented in the external device 20 communicatively connected to the electronic device 10. The electronic device 10 may implement the UI generation system 300 by exchanging data with the external device 20 using the communication circuitry 190.

According to an embodiment, the UI generation system 300 may include a data management module 310, a trigger management module 320, a UI generation module 330, a UI output module 340, a database 390, an application 3010, and/or an operating system (OS) 3020. The application 3010 may include, for example, at least one application installed in the electronic device 10. The OS 3020 may include an OS of the electronic device 10. The application 3010 and the OS 3020 may be components separate from the UI generation system 300.

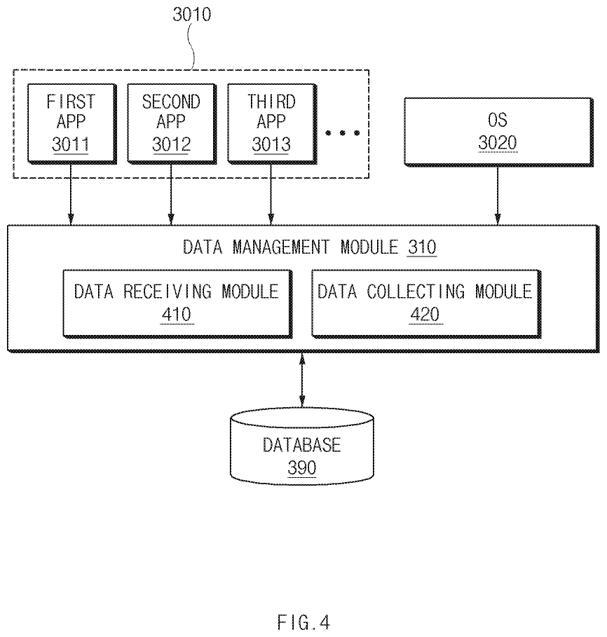

The data management module 310 may collect and store data. The data management module 310 may acquire data from the application 3010 and/or the OS 3020 and store the acquired data in the database 390. For example, the data management module 310 may acquire data from the application 3010 and/or the OS 3020 using the API/plugin management module 223 described above with reference to FIG. 2. In an example, the data management module 310 may acquire message information from a message application of the electronic device 10 and store the acquired information in the database 390. In an example, the data management module 310 may acquire schedule information from a schedule application of the electronic device 10 and store the acquired information in the database 390. In an example, the data management module 310 may acquire setting information of the OS 3020 (e.g., installed application information) and store the acquired information in the database 390. The data management module 310 may structuralize the acquired information and store the structured information in the database 390. Operations of the data management module 310 may be described later with reference to FIG. 4.

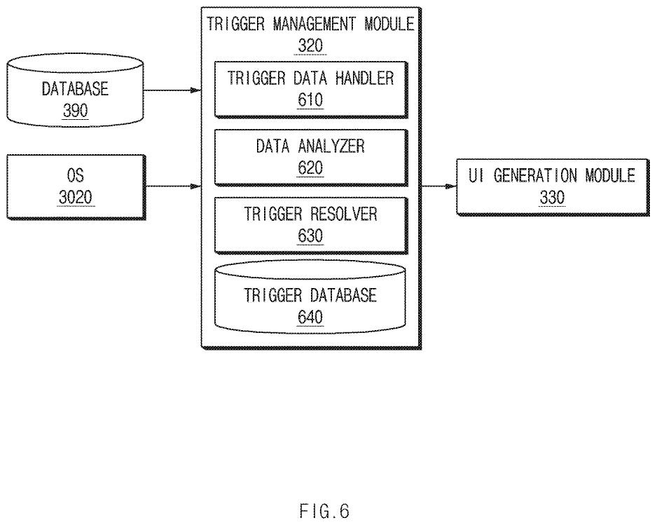

The trigger management module 320 may be configured to determine whether to generate a recommendation UI. For example, the trigger management module 320 may determine whether to generate the recommendation UI using information of the database 390 and/or information acquired from the OS 3020. The trigger management module 320 may identify a recommended action based on the acquired information and determine whether to generate a recommendation UI indicating the identified recommended action. When generation of the recommendation UI is determined, the trigger management module 320 may cause the UI generation module 330 to generate the recommendation UI. Operations of the trigger management module 320 may be described later with reference to FIG. 6.

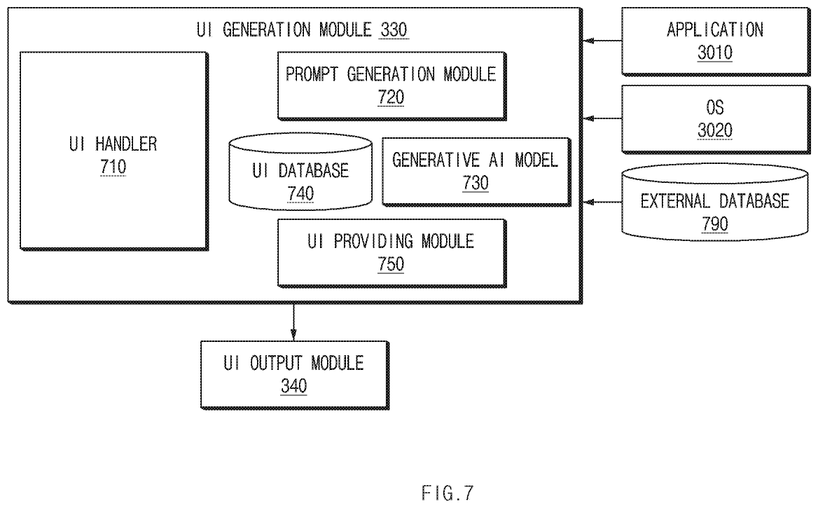

The UI generation module 330 may be configured to generate a UI. For example, the UI generation module 330 may generate the UI by inputting a generated prompt into a generative AI model (e.g., the generative AI model 250 of FIG. 2). In an example, the UI generation module 330 may generate the prompt based on information received from the trigger management module 320. Operations of the UI generation module 330 may be described later with reference to FIG. 7.

The UI output module 340 may be configured to output the UI generated by the UI generation module 330. For example, the UI output module 340 may output the generated UI through the display 160 of the electronic device 10 or through an external electronic device connected through the communication circuitry 190. For example, the UI output module 340 may correspond to the user interface 210 and/or the modification module 225 of FIG. 2. A description of the UI output module 340 may be provided later with reference to FIG. 7.

According to an embodiment, the electronic device 10 may be configured to provide, to a user, a UI including information about a recommended action using the UI generation system 300. The electronic device 10 may collect information from the application 3010 and/or the OS 3020 using the data management module 310. The electronic device 10 may identify, using the trigger management module 320, an intent and/or a goal from the collected information and identify a subsequent action from the intent and/or goal. For example, the electronic device 10 may identify an action predicted to be subsequently executed by the user and/or additional information (e.g., additional information associated with the subsequent action) by analyzing information (e.g., text, an image, and/or a video) displayed on the display 160 of the electronic device 10. For example, the electronic device 10 may analyze, in real-time, a conversation between the user and another party through a messenger application. The electronic device 10 may determine a need for providing a recommendation using the trigger management module 320.

When it is determined that a recommendation is required, the electronic device 10 may generate a recommendation UI using the UI generation module 330. The electronic device 10 may generate a prompt associated with a subsequent action and/or recommendation provision using the UI generation module 330. The UI generation module 330 may generate the recommendation UI by inputting the prompt into a generative AI model (e.g., the generative AI model 250 of FIG. 2). The electronic device 10 may generate the recommendation UI including the subsequent action and information associated with the subsequent action.

The electronic device 10 may provide (e.g., display) the generated recommendation UI. For example, the electronic device 10 may display the recommendation UI on at least a partial area of the display 160 using the UI output module 340. The recommendation UI may include, for example, at least one of a graphic object, a floating window, a popup window, an in-application message, a widget, or an icon. In an example, the electronic device 10 may provide the recommendation UI through an external device (e.g., a smart watch, wearable device, tablet, desktop, laptop, television (TV), and/or extended reality (XR) device) by transmitting information of the recommendation UI to the external device using the communication circuitry 190.

FIG. 4 illustrates a data management module of an electronic device according to an embodiment of the disclosure.

Referring to FIGS. 1 and 4, according to an embodiment, the data management module 310 may be configured to collect information from services (e.g., the application 3010 and/or the OS 3020) of the electronic device 10. In an example, the data management module 310 may collect information from the running application 3010 and/or the OS 3020 of the electronic device 10. The data management module 310 may collect information based on a specified event (e.g., input reception) and/or a specified period. The data management module 310 may store, in the database 390, information stored in the memory 130 of the electronic device 10, information acquired by an application (e.g., a received message, notification, and/or user input), and/or information acquired using the sensor 150. The data management module 310 may include a data receiving module 410 and a data collecting module 420.

The data receiving module 410 may receive data from the application 3010 and/or the OS 3020. The data receiving module 410 may receive data through a specified interface (e.g., an API). Each of the first application 3011, the second application 3012, and/or the third application 3013 may transmit specified information to the data receiving module 410 using a designated software development kit (SDK). For example, the data receiving module 410 may receive data through an interface defined by the SDK. The data may be processed into a data format specified by the SDK and then transmitted to the data receiving module 410. In an example, the data receiving module 410 may receive data through an interface (e.g., an API) provided by the OS 3020. The data receiving module 410 may store the received data in the database 390.

The data collecting module 420 may collect information through an interface (e.g., an API) provided by the OS 3020. The data collecting module 420 may be configured to collect arbitrary types of data (e.g., text, an image, and/or a video). For example, the data collecting module 420 may acquire text information and/or image information within a displayed screen (e.g., page) through a contents capture service. In an example, the data collecting module 420 may acquire text information and/or image information from the displayed screen based on a text recognition and/or image recognition algorithm. For example, the data collecting module 420 may acquire information about a notification of the electronic device 10 (e.g., an application associated with the notification and/or content of the notification) using a notification service. For example, the data collecting module 420 may acquire information about media (e.g., an image and/or a video) currently being played on the electronic device 10 (e.g., a type of the media, a title of the media, and/or a media playback application) through a media service. For example, the data collecting module 420 may acquire information about a running application (e.g., an application name and/or an execution environment of the application (e.g., foreground or background)) using an application usage receive service. The data collecting module 420 may store the collected data in the database 390. For example, the data collecting module 420 may process the collected data into a specified data format and then store the data in the specified data format in the database 390.

The data management module 310 may store data of a specified data format in the database 390. For example, the specified data format may include structured text (e.g., json and/or jsonl). For example, the specified data format may include information about a source, a type, and data (e.g., text information extracted from text, an image, and/or a video). The source may include information about an entity providing the data (e.g., a name of an application providing the data). The type may include, for example, a composite type and a primitive type. Composite-type data may be referred to as data in which data of a plurality of types are mixed. Primitive-type data may be referred to as data of a single type. In an example, type information of the primitive-type data may include type information of the data (e.g., an event, a message, and/or media). The data may include detailed information according to the type information of the data. For example, the data may be configured in a preset format (e.g., fields, field order, and/or detailed contents) according to the type information of the data. For example, the detailed information may include at least a portion of extracted text information, at least a portion of text information extracted based on image recognition (e.g., keywords of an image extracted based on image recognition), and/or at least a portion of text information extracted based on recognition of images of a video.

In the above example, the database 390 including structured text has been described. However, embodiments of the disclosure are not limited thereto. For example, the data collecting module 420 may store collected text, images, and/or videos in the data collecting module 420. For example, the data collecting module 420 may store, in the database 390, an image (e.g., a displayed image) mapped to text information together with text information (e.g., structured text) associated with the displayed image. The data collecting module 420 may store, in the database 390, an image (e.g., an image of a playing video) and/or a video (e.g., the playing video) mapped to text information together with text information (e.g., structured text) associated with the playing video.

For example, the data management module 310 may acquire schedule information from a calendar application. The data management module 310 may acquire the schedule information when a schedule is input or when a specified period arrives. The data management module 310 may store the schedule information in the database 390 as data in a specified format. For example, a source of the schedule information may be set as a calendar application (e.g., an application package name). A type of the schedule information may be set as an event. Data of the schedule information may include, for example, at least one of a start time of a schedule, an end time of the schedule, a title, a location, or attendee information (e.g., attendee name, email, and/or telephone number) of the schedule.

For example, the data management module 310 may acquire message information from a message application. The data management module 310 may acquire the message information when a message is received, when a message is transmitted, or when a specified period arrives. The data management module 310 may store the message information in the database 390 as data in a specified format. For example, a source of the message information may be set as a message application (e.g., an application package name). A type of the message information may be set as a message. Data of the message information may include, for example, at least one of a conversation type, counterpart information (e.g., a name, email, and/or telephone number), or message content. The conversation type may include a one-to-one conversation or a group conversation. For example, the data management module 310 may store a portion of content included in the message as the message content. The data management module 310 may identify at least one keyword (e.g., an intent and/or an entity) from content of the message using an artificial intelligence model (e.g., an LLM) and store the identified keyword as the message content. In an example, the message may include an image. The data management module 310 may identify at least one keyword (e.g., a keyword extracted based on recognition of an object in the image) from the image and store the identified keyword as the message content.

The database 390 may store data in a specified format. The database 390 may include, for example, a knowledge-based graph database. For example, the database 390 may store information about relationships between pieces of data. Data within the database 390 may be used for trigger determination and prompt generation, as described later.

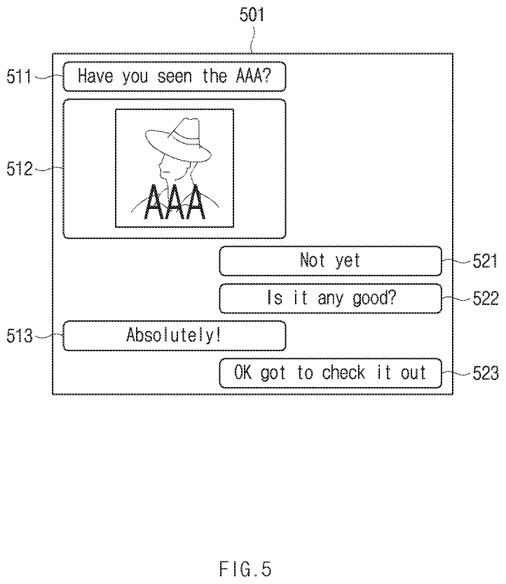

FIG. 5 illustrates a message screen of an electronic device according to an embodiment of the disclosure.

Referring to FIGS. 1, 3, and 5, a message application of the electronic device 10 may display a message screen 501 on the display 160. For example, the first received message 511 may include information about a recommendation of a movie (e.g., AAA). The second received message 512 may include information about the recommended movie (e.g., an image of the movie). The first transmitted message 521 may include information (e.g., not watched) indicating whether a user (e.g., a user of the electronic device 10) has watched the recommended movie. The second transmitted message 522 may include an inquiry for information about the recommended movie. The third received message 513 may include an evaluation of the recommended movie. The third transmitted message 523 may include the user's reaction to the recommended movie.

According to an embodiment, the electronic device 10 may identify at least one keyword from the conversation of FIG. 5. For example, the electronic device 10 may identify the at least one keyword using the data management module 310. The electronic device 10 may identify the at least one keyword from the conversation of FIG. 5 using an artificial intelligence model (e.g., an LLM). For example, the electronic device 10 may identify “AAA,” which is a keyword corresponding to information about the recommended movie, from the first received message 511 and/or the second received message 512. The electronic device 10 may identify keywords such as “not yet,” “absolutely,” and “got to check it out” from the first transmitted message 521, the third received message 513, and the third transmitted message 523. In an example, the electronic device 10 may identify an intent of watching the movie “AAA” from the identified keywords.

In an example, the electronic device 10 may store the identified keywords and/or intent in the database 390. The electronic device 10 may store each message as separate structured data in the database 390. The electronic device 10 may store messages transmitted and received within a specified time as one piece of structured data in the database 390.

In the example of FIG. 5, a source of the structured data may be set as the message application, and a type thereof may be set as a message. A data field of the structured data may include the identified at least one keyword and/or intent. In an example, the electronic device 10 may identify additional information from the at least one keyword and/or intent and store the identified additional information in the structured data. For example, from the identified intent of “watching AAA,” the electronic device 10 may identify information about an application (e.g., a content provider application) capable of displaying AAA and store the identified information in the structured data. For example, when the recommended “AAA” is a TV series show, the electronic device 10 may identify latest episode information of the show and store the latest episode information in the structured data.

FIG. 6 illustrates a trigger management module of an electronic device according to an embodiment of the disclosure.

Referring to FIGS. 1 and 6, according to an embodiment, the trigger management module 320 may determine triggering of generation of a recommendation UI. For example, the trigger management module 320 may determine triggering of generation of the recommendation UI using information stored in the database 390 or information acquired from the OS 3020. For example, the trigger management module 320 may include a trigger data handler 610, a data analyzer 620, a trigger resolver 630, and/or a trigger database 640.

The trigger data handler 610 may acquire data from the database 390 and/or the OS 3020 and transmit the acquired data to the data analyzer 620 or the trigger resolver 630. The trigger data handler 610 may perform data transmission between the data analyzer 620 and the trigger resolver 630. The trigger data handler 610 may transmit information for UI generation to the UI generation module 330. The trigger data handler 610 may be referred to as an interface between the trigger management module 320 and another component.

The trigger resolver 630 may determine triggering of generation of a recommendation UI using information received from the trigger data handler 610 (e.g., information acquired from the database 390 and/or the OS 3020). When triggering of generation of a recommendation UI associated with specific data is determined, the trigger resolver 630 may transmit related information to the data analyzer 620 so that a recommended action associated with the specific data may be generated. When it is determined not to trigger, the electronic device 10 may stop performing operations described later and may continue to collect information as described above.

For example, the trigger resolver 630 may acquire schedule information stored in the database 390. The trigger resolver 630 may determine (e.g., trigger) generation of a recommendation UI when a start time of a stored schedule is within a specified time from a current time. In an example, the trigger resolver 630 may determine generation of the recommendation UI based on a policy stored in the trigger database 640. The trigger database 640 may store, for example, information about conditions (e.g., policies) for generation of the recommendation UI. The trigger database 640 may store information about a plurality of conditions for generation of the recommendation UI mapped to a source or type of each piece of data.

For example, the trigger resolver 630 may acquire message information stored in the database 390. When a keyword indicating a user's intent and/or willingness is identified from the message information, the trigger resolver 630 may determine generation of a recommendation UI associated with the message information. For example, the keyword indicating the user's intent may include a keyword indicating the user's intent to perform an action. The keyword indicating the user's willingness may include a keyword indicating agreement with a recommended action of another party (e.g., a keyword indicating strong affirmation) and/or a keyword indicating the user's willingness to perform the recommended action. In the example of FIG. 5, the trigger resolver 630 may determine generation of the recommendation UI based on keywords such as “absolutely” and/or “got to check it out.”

In the example of FIG. 5, an example in which the trigger resolver 630 determines generation of a recommendation UI from a conversation between the user and one counterpart has been described. However, embodiments of the disclosure are not limited thereto. For example, the trigger resolver 630 may determine generation of the recommendation UI based on information stored inside the electronic device 10 and/or external search information. In the example of FIG. 5, the trigger resolver 630 may identify a recommendation target, namely the movie “AAA.” In an example, the trigger resolver 630 may search for the movie AAA from information stored in the electronic device 10. For example, the trigger resolver 630 may acquire information about AAA (e.g., a conversation and/or schedule associated with the keyword “AAA”) from schedule information and/or another conversation (e.g., a conversation with another counterpart different from the example of FIG. 5) stored in the electronic device 10. The trigger resolver 630 may determine generation of the recommendation UI using information stored in the electronic device 10. In an example, the trigger resolver 630 may perform a web search for information about “AAA” and determine generation of the recommendation UI based on the searched information. For example, the trigger resolver 630 may acquire popularity information of AAA (e.g., ratings, reservation rates, search frequency, and/or search ranking) from a web-based database and determine generation of the recommendation UI when the popularity is equal to or greater than a specified value.

The data analyzer 620 may analyze information received from the trigger data handler 610 (e.g., information acquired from the database 390 and/or the OS 3020). For example, the data analyzer 620 may identify a user intent from the information received from the trigger data handler 610. The data analyzer 620 may acquire at least one keyword from data in a specified format and identify an intent from the acquired keyword. For example, the data analyzer 620 may identify the intent from the keyword using an artificial intelligence model (e.g., an LLM).

The data analyzer 620 may identify an intent and a recommended action based on information (e.g., information acquired from the database 390 and/or the OS 3020). For example, the data analyzer 620 may acquire the recommended action by inputting the identified intent and the identified keyword into an artificial intelligence model. For example, the data analyzer 620 may acquire the intent and the recommended action by inputting the identified keyword into the artificial intelligence model. The recommended action may include a series of actions for realizing a goal corresponding to the intent. The recommended action may include generation of a recommendation UI for realizing the goal corresponding to the intent.

The data analyzer 620 may acquire additional information based on information (e.g., information acquired from the database 390 and/or the OS 3020). For example, the data analyzer 620 may acquire information associated with a keyword, intent, goal, and/or recommended action through an external server (e.g., a search server). The data analyzer 620 may acquire recommendation information associated with the keyword, intent, goal, and/or recommended action and include the acquired recommendation information in information of the recommended action.

The trigger data handler 610 may transmit information of the recommended action generated by the data analyzer 620 to the UI generation module 330. For example, the information of the recommended action generated by the data analyzer 620 may include structured data (e.g., json or jsonl). The information of the recommended action may include goal information, type information, and/or data information. The goal information may include information about a goal identified by the trigger management module 320. For example, when the recommended action is generation of a recommendation UI associated with playback of specific media, the goal information may be set as generation of a UI. The type information may indicate a goal of the recommended action (e.g., a goal of a final action (generation of the recommendation UI)). When the recommended action is generation of a recommendation UI associated with playback of specific media, the type information may be set as media playback. The data information may include information associated with data related to the recommended action. When the recommended action is generation of a recommendation UI associated with playback of specific media, the data information may include information associated with the specific media. For example, the data information may include information about an application for playing the specific media, a name of the specific media, and/or additional information (e.g., episode information).

In the example of FIG. 5, the data analyzer 620 may identify an intent of watching AAA from the conversation. The data analyzer 620 may acquire information about an application (e.g., a content provider application) capable of playing AAA using AAA information. The data analyzer 620 may identify a goal of playing AAA through the application from the intent of watching AAA. The data analyzer 620 may identify a recommended action for achieving the identified goal. The recommended action may include generation of a recommendation UI for playing AAA through the application. The data analyzer 620 may set the goal information of the recommended action information as UI generation, set the type information of the recommended action information as media playback, and set the data information as information associated with the movie AAA (e.g., a movie name and/or information about an application capable of playing the movie).

FIG. 7 illustrates a UI generation module of an electronic device according to an embodiment of the disclosure.

Referring to FIGS. 1 and 7, according to an embodiment, the electronic device 10 may generate at least one prompt based on recommended action information. The electronic device 10 may generate a UI based on the at least one prompt. For example, the electronic device 10 may generate the prompt and the UI using the UI generation module 330. For example, the UI generation module 330 may include a UI handler 710, a prompt generation module 720, a generative AI model 730, a UI database 740, and/or a UI providing module 750.

The UI handler 710 may control data exchange inside and outside the UI generation module 330 and operations of the UI generation module 330. For example, the UI handler 710 may receive recommended action information from the trigger management module 320 of FIG. 3 and transmit the received recommended action information to the prompt generation module 720. For example, the UI handler 710 may acquire information from the application 3010, the OS 3020, and/or an external database 790. The external database 790 may refer to, for example, a database of any electronic device located outside the electronic device 10.

The prompt generation module 720 (e.g., the prompt design module 221 of FIG. 2) may generate at least one prompt based on the recommended action information. For example, the prompt generation module 720 may generate the at least one prompt by processing the recommended action information using an artificial intelligence model (e.g., an LLM) or a generative AI model. In an example, the prompt may have a format processable by the generative AI model.

The generative AI model 730 may be configured to perform at least one operation based on the prompt. The generative AI model 730 may include, for example, a plurality of generative AI models configured to perform specified operations. The generative AI model 730 may include a GAN, VAE, or Style GAN. The generative AI model 730 may be configured to perform data acquisition, UI generation, and/or response generation.

For example, the prompt generation module 720 may generate a prompt for collecting additional information (e.g., information required for performing the recommended action) associated with the recommended action information. The prompt generation module 720 may generate a prompt for acquiring, from the external database 790, additional information associated with the recommended action information using information included in the recommended action information. The generative AI model 730 may collect additional information from, for example, the database 390, the application 3010, the OS 3020, and/or the external database 790 of FIG. 3.

For example, the prompt generation module 720 may generate a prompt for collecting information about a user and/or the electronic device 10. The prompt generation module 720 may generate a prompt for acquiring hardware information of the electronic device 10 required for performing the recommended action. The generative AI model 730 may acquire required user information and/or information about the electronic device 10 (e.g., resolution information of the display 160 and/or network connection information of the communication circuitry 190) from the database 390, the application 3010, the OS 3020, and/or the external database 790 of FIG. 3.

For example, the prompt generation module 720 may generate a prompt for generating a structure of the recommendation UI (e.g., a size of the UI, a position of the UI, components within the UI, positions of the components, component-related operations, and/or UI-related color information). The prompt generation module 720 may generate the prompt based on previously acquired additional information, user information, and/or information about the electronic device 10. The generative AI model 730 may generate the structure of the recommendation UI based on the prompt. In an example, the generative AI model 730 may be configured to generate the recommendation UI corresponding to the prompt using a plurality of reference UIs stored in the UI database 740.

For example, the prompt generation module 720 may generate a prompt for acquiring UI resources. The generative AI model 730 may be configured to acquire UI resources indicated by the prompt from the UI database 740, the application 3010, the OS 3020, and/or the external database 790.

According to an embodiment, the UI providing module 750 may generate the recommendation UI based on the acquired UI resources and the structure of the UI. For example, the UI providing module 750 may generate the recommendation UI by mapping the acquired UI resources to the structure of the UI. The recommendation UI may include information corresponding to the recommended action (e.g., information for executing the recommended action). For example, the UI providing module 750 may generate the recommendation UI according to a widget processing flow. The UI providing module 750 may generate the recommendation UI in the form of a widget within an application (e.g., an in-app message) or a popup widget (e.g., a floating view).

The UI output module 340 may be configured to output the recommendation UI generated by the UI generation module 330. For example, the UI output module 340 may output the recommendation UI through the display 160 of the electronic device 10. For example, the UI output module 340 may cause the external device 20 to output the recommendation UI by transmitting information about the recommendation UI using the communication circuitry 190. For example, the UI output module 340 may correspond to the modification module 225 of FIG. 2.

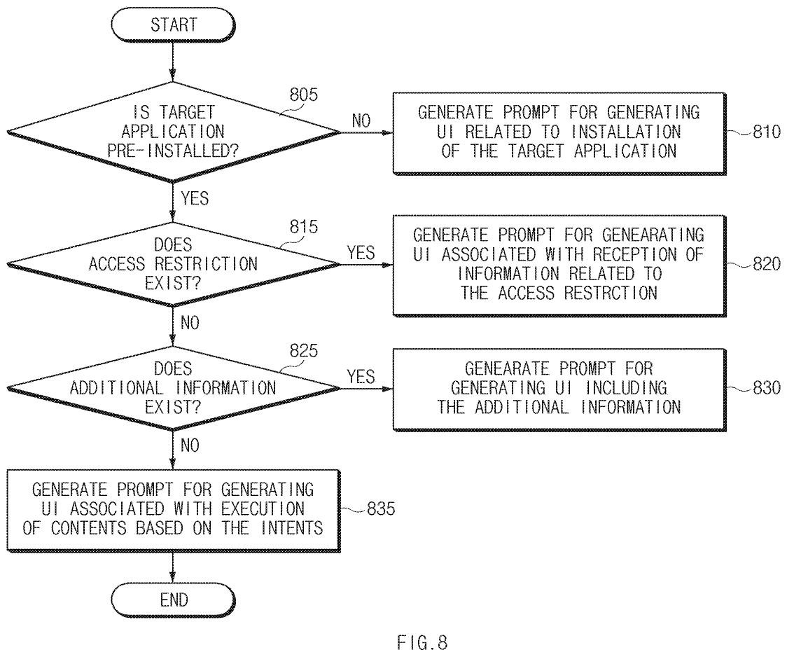

FIG. 8 is a flowchart of a method for generating a prompt by an electronic device according to an embodiment of the disclosure.

Referring to FIG. 8, operations described below with reference to FIG. 8 may be referred to as operations of the electronic device 10 of FIG. 1. An order of the operations described below with reference to FIG. 8 is merely an example, and embodiments of the disclosure are not limited thereto. For example, at least some of the operations may be performed in an order different from that of FIG. 8 or may be performed substantially simultaneously with other operations of FIG. 8. At least some of the operations described below with reference to FIG. 8 may be omitted. Unless otherwise described, operations described above with reference to FIG. 7 may be referenced in the description of FIG. 8.

In the example of FIG. 8, the recommended action may be assumed to be generation of a recommendation UI for playback of the movie AAA using the M application. For example, the electronic device 10 may identify the recommended action according to the example of FIG. 5.

In operation 805, the electronic device 10 may determine whether a target application (e.g., the M application) is pre-installed. For example, the electronic device 10 may acquire installed application information from the database 390 or the OS 3020 of FIG. 3 and determine whether the M application is installed based on the acquired information. For example, the electronic device 10 may generate, using the prompt generation module 720, a prompt for checking whether the M application is installed (e.g., “please check whether the M application is installed”). The electronic device 10 may acquire a result value by inputting the prompt into the generative AI model 730 and determine whether the M application is installed based on the result value. Information about installation of the target application may be included in additional information, user information, or information about the electronic device 10 previously acquired by the generative AI model 730 before operation 805.

When the target application is not installed (e.g., operation 805—NO), in operation 810, the electronic device 10 may generate a prompt for generating a UI associated with installation of the target application. For example, when the M application is not installed, the prompt generation module 720 may generate a prompt instructing generation of a recommendation UI recommending installation of the M application (e.g., “please generate an M application installation suggestion UI”). In an example, the prompt generation module 720 may generate a plurality of prompts. A first prompt may instruct generation of the M application installation suggestion UI, a second prompt may instruct a background color of the UI, a third prompt may instruct a position and size of a graphic object corresponding to an installation shortcut, and a fourth prompt may instruct a shortcut (e.g., an installation link of the application) and/or search operation (e.g., a search within an application store) for the graphic object. The plurality of prompts may be input into the generative AI model 730 simultaneously or sequentially. When the plurality of prompts are input simultaneously, the generative AI model 730 may generate the recommendation UI based on the plurality of prompts. In an example, after a result based on the first prompt is generated, a subsequent prompt may be sequentially input into the generative AI model 730. The subsequent prompt may be processed by the generative AI model 730 as an additional command for the result of the preceding prompt.

The UI output module 340 may display a recommendation UI recommending installation of the M application. For example, the prompt generation module 720 may generate a prompt instructing acquisition of graphic resources within the UI by referring to the UI database 740. The generative AI model 730 may acquire the graphic resources based on the prompt and generate the UI based on the acquired graphic resources and the UI structure. The UI output module 340 may output the generated UI. When the M application is installed based on an input to the recommendation UI recommending installation of the M application, the electronic device 10 may perform subsequent operation 815.

When the target application is installed (e.g., operation 805—YES), in operation 815, the electronic device 10 may determine whether an access restriction exists. For example, the electronic device 10 may determine whether login and/or authentication for access is required in performing the recommended action. For example, the electronic device 10 may acquire login information of the target application from the database 390, the application 3010, or the OS 3020 of FIG. 3 and determine whether the access restriction exists based on the acquired information. For example, the electronic device 10 may generate, using the prompt generation module 720, a prompt for checking whether the M application is logged in (e.g., “please check whether the M application is logged in”). The electronic device 10 may acquire a result value by inputting the prompt into the generative AI model 730 and determine whether the M application is logged in based on the result value. Information about login of the target application may be included in additional information, user information, or information about the electronic device 10 previously acquired by the generative AI model 730 before operation 815.

When the access restriction exists (e.g., operation 815—YES), in operation 820, the electronic device 10 may generate a prompt for generating a UI associated with reception of information related to the access restriction. For example, when login to the M application is required, the prompt generation module 720 may generate a prompt instructing generation of a recommendation UI recommending login to the M application (e.g., “please generate an M application login suggestion UI”). In an example, the prompt generation module 720 may generate a plurality of prompts. A first prompt may instruct generation of the M application login suggestion UI, a second prompt may instruct a background color of the UI, a third prompt may instruct a position and size of a graphic object corresponding to an application execution link, and a fourth prompt may instruct an operation (e.g., intent or deep link setting) of a shortcut (e.g., an application execution link) for the graphic object. As described above, the plurality of prompts may be input into the generative AI model 730 simultaneously or sequentially.

The UI output module 340 may display a recommendation UI recommending login to the M application. For example, the prompt generation module 720 may generate a prompt instructing acquisition of graphic resources within the UI by referring to the UI database 740. The generative AI model 730 may acquire the graphic resources based on the prompt and generate the UI based on the acquired graphic resources and the UI structure. The UI output module 340 may output the generated UI. When login to the M application is completed based on an input to the recommendation UI recommending login to the M application, the electronic device 10 may perform subsequent operation 825.

In relation to operation 820, it has been described that, when the access restriction exists, a UI for receiving information for access is provided. However, embodiments of the disclosure are not limited thereto. For example, the UI output module 340 may output a recommendation UI generated based on currently accessible information (e.g., information accessible even without login). The UI output module 340 may output a UI associated with content execution based on an intent (e.g., the UI generated according to operation 830) based on the currently accessible information.

When the access restriction does not exist (e.g., operation 815—NO), in operation 825, the electronic device 10 may determine whether additional information exists. For example, the electronic device 10 may acquire the additional information from the database 390, the application 3010, or the OS 3020 of FIG. 3. For example, the electronic device 10 may generate a prompt for acquiring the additional information using the prompt generation module 720. The electronic device 10 may acquire a result value by inputting the prompt into the generative AI model 730 and acquire the additional information based on the result value.

When the additional information does not exist (e.g., operation 825—NO), in operation 835, the electronic device 10 may generate a prompt for generating a UI associated with content execution based on the intent. For example, the prompt generation module 720 may generate a prompt for generating a UI structure and a prompt for acquiring UI resources. The generative AI model 730 may generate a recommendation UI based on the generated prompts. The generated recommendation UI may include information for playback of content (e.g., application execution, media playback, and/or a link to a specified view). For example, the information for playback of the content may include a deep link action URI (uniform resource indicator).

For example, the prompt for generating the structure may include prompts instructing a position of an application icon, a size of the application icon, a background color of the UI, a position of a thumbnail, a size of the thumbnail, a size of a graphic object, a position of the graphic object, and/or an operation associated with the graphic object. For example, the prompt for acquiring the UI resources may include a prompt instructing acquisition of graphic resources within the UI by referring to the UI database 740 or the external database 790.

According to an embodiment, the generative AI model 730 may generate the recommendation UI based on the prompt. The prompt may omit some information about the recommendation UI. For example, the prompt may not include information about a size or position of the recommendation UI. The generative AI model 730 may supplement the omitted information using information stored in the UI database 740.

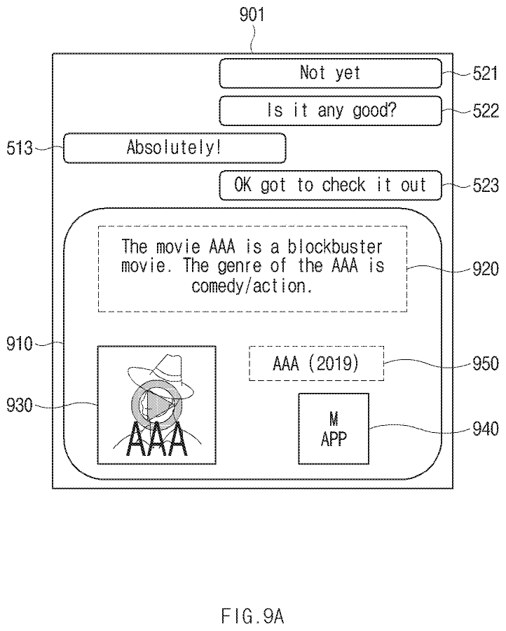

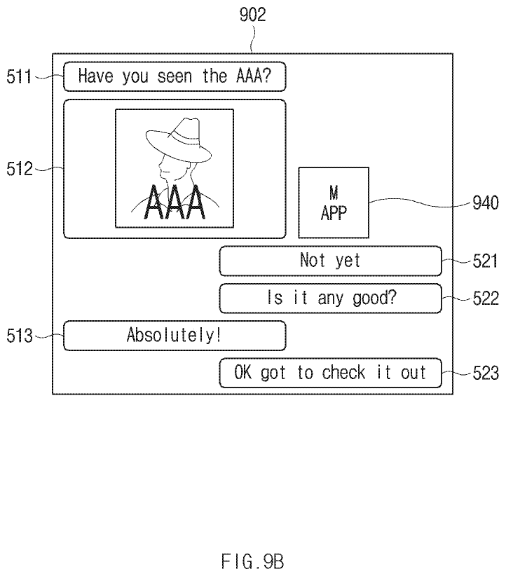

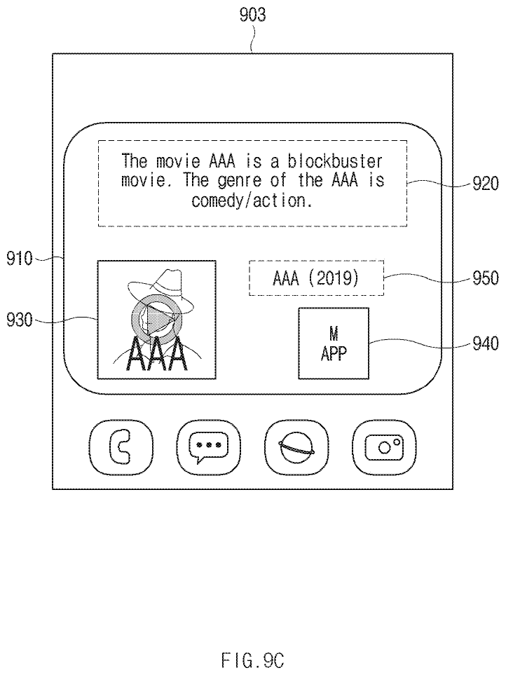

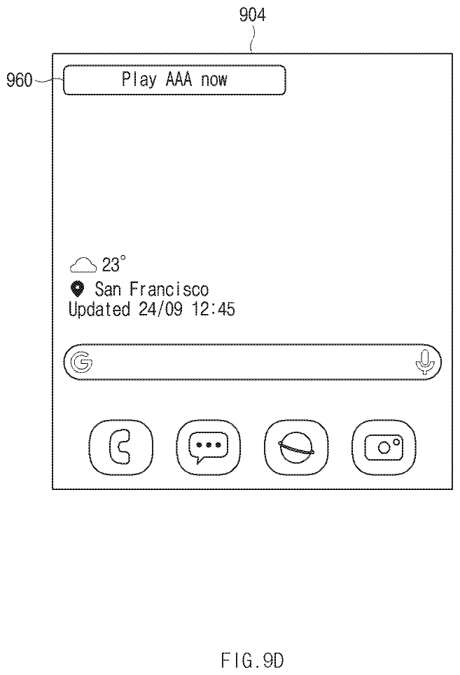

The generated recommendation UI may be output by the UI output module 340. Based on an input to the recommendation UI (e.g., an input instructing termination of display of the recommendation UI or an input for performing the recommended action instructed by the recommendation UI), the UI output module 340 may terminate output of the recommendation UI. Hereinafter, various examples of output of the recommendation UI may be described with reference to FIGS. 9A to 9D, 10, and 11.

FIG. 9A illustrates a recommendation UI of an electronic device according to an embodiment of the disclosure.

Referring to FIGS. 1 to 8 and 9A, according to an embodiment, the electronic device 10 may display a recommendation UI 910. A first screen 901 of FIG. 9A may be a subsequent screen of the message screen 501 of FIG. 5. For example, the electronic device 10 may display the recommendation UI 910 on an execution screen of a currently running application or display the recommendation UI 910 as an in-app message of the currently running application.

For example, the electronic device 10 may generate the recommendation UI 910. In an example, the recommendation UI 910 may include a UI generated based on the prompt generated according to operation 830 of FIG. 8. The recommendation UI 910 may include, for example, additional information 920, a thumbnail 930 of the movie AAA, a link image 940 of the M application, and/or a title 950. For example, the electronic device 10 may acquire the additional information 920, the thumbnail 930, the link image 940, and/or the title 950 from a database of the M application. For example, the electronic device 10 may generate a prompt for acquiring UI resources using the prompt generation module 720 of FIG. 7 and acquire the UI resources by inputting the generated prompt into the generative AI model 730. For example, in response to an input to the thumbnail 930, the electronic device 10 may be configured to play a movie corresponding to the thumbnail 930. For example, in response to an input to the link image 940, the electronic device 10 may be configured to execute an application corresponding to the link image 940. For example, operations associated with an input to the thumbnail 930 and/or the link image 940 of the electronic device 10 may be configured based on the prompt related to the structure generation described above.

In an example, the prompt generation module 720 may generate a prompt instructing a type in which the recommendation UI 910 is to be output. For example, the prompt may instruct the recommendation UI 910 to be output (e.g., immediately output) on an execution screen of a currently running application. For example, the recommendation UI 910 may be output in the form of a widget, an in-app message, or a floating window. For example, the generative AI model 730 may generate the recommendation UI 910 according to the output type instructed by the prompt.

In an example, the generative AI model 730 may determine an output type of the recommendation UI 910 based on context information. Even when the output type is not instructed by the prompt, the generative AI model 730 may determine the output type based on user information and/or information about the electronic device 10. For example, when a movement speed of the electronic device 10 is less than a threshold value or when the electronic device 10 is located at a specified location (e.g., a home, company, or school), the generative AI model 730 may cause the recommendation UI 910 to be output (e.g., immediately output) on the execution screen of the currently running application.

FIG. 9B illustrates a recommendation UI of an electronic device according to an embodiment of the disclosure.

Referring to FIGS. 1 to 8 and 9B, according to an embodiment, the electronic device 10 may display a second screen 902. The second screen 902 of FIG. 9B may be a subsequent screen of the message screen 501 of FIG. 5. For example, the electronic device 10 may display a recommendation UI on an execution screen of a currently running application or display the recommendation UI as an in-app message of the currently running application.

In the example of FIG. 9B, the recommendation UI may be configured as a link image 940 of the M application capable of displaying the movie AAA. For example, by displaying the link image 940 adjacent to the second received message 512, the electronic device 10 may recommend an operation of displaying the movie AAA recommended by the second received message 512 through the M application. As described above with reference to FIG. 9A, the electronic device 10 may display the link image 940 on the execution screen of the currently running application. For example, the electronic device 10 may determine a display timing of the link image 940 based on a user context (e.g., an intent identified from the context). The electronic device 10 may display the link image 940 when a positive intent of the user such as the third transmitted message 523 is identified. For example, the electronic device 10 may display the link image 940 when the second received message 512 is received.

With reference to FIGS. 9A and 9B, examples in which the electronic device 10 provides the recommendation UI on a currently displayed execution screen have been described. However, embodiments of the disclosure are not limited thereto. For example, as described later with reference to FIGS. 9C and 9D, the electronic device 10 may provide the recommendation UI after termination of display of the currently displayed execution screen.

FIG. 9C illustrates a recommendation UI of an electronic device according to an embodiment of the disclosure.

Referring to FIGS. 1 to 8 and 9C, according to an embodiment, the electronic device 10 may display the recommendation UI 910. A third screen 903 of FIG. 9C may correspond to a screen (e.g., a home screen of the electronic device 10) displayed after display of the message screen 501 of FIG. 5 is terminated. For example, the electronic device 10 may be configured to display the recommendation UI 910 after display of an execution screen of an application (e.g., a message application) that triggered the recommended action is terminated.

For example, the electronic device 10 may generate the recommendation UI 910 based on the prompt generated according to operation 830 of FIG. 8. Unless otherwise described, the operation of generating the recommendation UI 910 may refer to the above description related to FIG. 9A.

In an example, the prompt generation module 720 may generate a prompt instructing a type in which the recommendation UI 910 is to be output. For example, the prompt may instruct the recommendation UI 910 to be output (e.g., delayed output) when display of the execution screen of the currently running application is terminated. For example, the recommendation UI 910 may be output in the form of a widget, popup, or floating window. For example, the generative AI model 730 may generate the recommendation UI 910 according to the output type instructed by the prompt.

In an example, the generative AI model 730 may determine the output type of the recommendation UI 910 based on context information. Even when the output type is not instructed by the prompt, the generative AI model 730 may determine the output type based on user information and/or information about the electronic device 10. For example, when a movement speed of the electronic device 10 is greater than or equal to a threshold value or when the electronic device 10 is not located at a specified location (e.g., a home, company, or school), the generative AI model 730 may cause the recommendation UI 910 to be output (e.g., delayed output) when display of the execution screen of the currently running application is terminated.

FIG. 9D illustrates a recommendation UI of an electronic device according to an embodiment of the disclosure.

Referring to FIGS. 1 to 8 and 9D, according to an embodiment, the electronic device 10 may display a recommendation UI 960. A fourth screen 904 of FIG. 9D may correspond to a screen (e.g., a home screen of the electronic device 10) displayed after display of the message screen 501 of FIG. 5 is terminated. In the example of FIG. 9D, the recommendation UI 960 may include a link (e.g., a deep link within an application) of the M application capable of displaying the movie AAA.

With reference to FIGS. 9A to 9D, various forms of recommendation UIs 960 have been described. However, embodiments of the disclosure are not limited thereto. For example, the electronic device 10 may provide a recommendation in the form of a simple link (e.g., a deep link). For example, the electronic device 10 may register the recommended action as a schedule and provide the recommendation UI as a registered schedule reminder. For example, the electronic device 10 may provide information about the recommended action through a notification message (e.g., a system notification).

With reference to FIGS. 9A to 9D, examples based on the message conversation of FIG. 5 have been described. However, embodiments of the disclosure are not limited thereto. According to an embodiment, the electronic device 10 may identify a recommended action from a conversation associated with a call (e.g., a video call or voice call). For example, the electronic device 10 may perform automatic speech recognition on voice transmitted and received through the call. The electronic device 10 may identify the recommended action based on text data acquired through the automatic speech recognition. For example, the electronic device 10 may identify the recommended action according to the method described above with reference to FIGS. 5 to 8. When provision of the recommendation UI is determined, the electronic device 10 may provide the recommendation UI for the recommended action after termination of the call. For example, the electronic device 10 may provide the recommendation UI according to the examples described above with reference to FIGS. 9C and 9D.

In the examples of FIGS. 9A to 9D, the electronic device 10 has been described as determining one output form. However, embodiments of the disclosure are not limited thereto. For example, the electronic device 10 may be configured to provide the recommendation UI while changing the output form. The electronic device 10 may first provide the recommendation UI of FIG. 9A or 9B and then provide the recommendation UI of FIG. 9C or 9D when display of the execution screen of the corresponding application (e.g., the message application) is terminated.

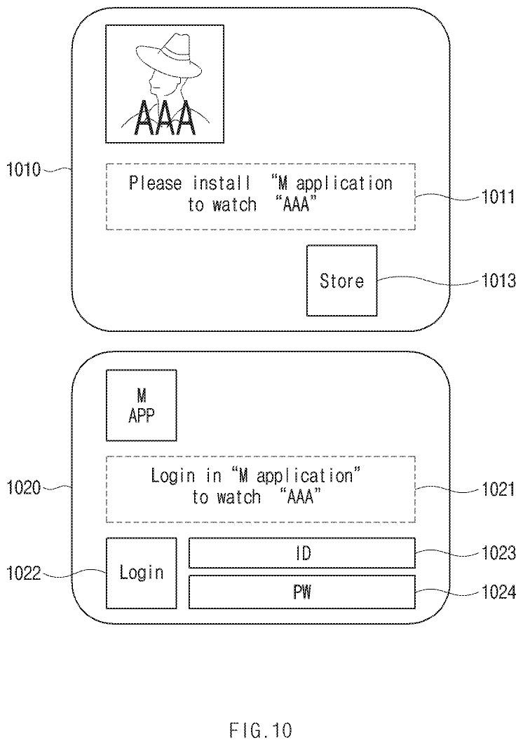

FIG. 10 illustrates additional information UIs of an electronic device according to an embodiment of the disclosure.

Referring to FIGS. 1 to 8 and 10, according to an embodiment, the electronic device 10 may output at least one additional information UI for acquiring additional information. Since the additional information UI is a UI corresponding to a recommended action of acquiring the additional information, the additional information UI may also be referred to as a recommendation UI.

The electronic device 10 may output a first additional information UI 1010. For example, the electronic device 10 may generate the first additional information UI 1010 using the prompt generated according to operation 810 of FIG. 8. The first additional information UI 1010 may include, for example, guide information 1011 guiding installation of an uninstalled application and an installation link 1013 of the application. When an input to the installation link 1013 is received, the electronic device 10 may display a screen (e.g., a store page) for installation of the application.

The electronic device 10 may output a second additional information UI 1020. For example, the electronic device 10 may generate the second additional information UI 1020 using the prompt generated according to operation 820 of FIG. 8. The second additional information UI 1020 may include, for example, guide information 1021 guiding login to the application, a login image 1022, an ID input field 1023, and a password input field 1024.

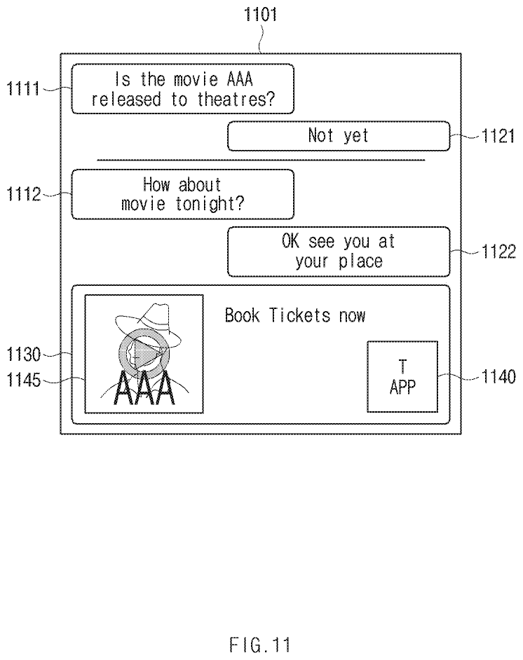

FIG. 11 illustrates a recommendation UI of an electronic device according to an embodiment of the disclosure.

Referring to FIGS. 1, 3, and 11, the message application of the electronic device 10 may display a message screen 1101 on the display 160. For example, the first received message 1111 may include an inquiry about release of a movie (e.g., AAA). The first transmitted message 1121 may include information indicating that the movie has not yet been released. The second received message 1112 may be a message received after a specified period has elapsed since transmission of the first transmitted message 1121. The second received message 1112 may include a proposal for watching the movie. The second transmitted message 1122 may include an intent of agreement to watch the movie.

In an example, the electronic device 10 may generate a recommendation UI 1130 using temporally non-consecutive data. For example, the electronic device 10 may determine generation of the recommendation UI 1130 using the trigger management module 320. Based on the proposal (e.g., “how about”) of the second received message 1112 and the agreement (e.g., “OK”) of the second transmitted message 1122, the trigger management module 320 may determine generation of the recommendation UI 1130.

In the example of FIG. 11, the second received message 1112 and the second transmitted message 1122 may not include information about a movie to be watched. In an example, the UI generation module 330 may acquire information (e.g., AAA) about the movie to be watched from the first received message 1111 stored in the database 390. For example, the electronic device 10 may acquire additional information from a conversation history with the same counterpart.

The electronic device 10 may display the recommendation UI 1130 generated by the UI generation module 330. For example, the recommendation UI 1130 may include a thumbnail 1145 and an application link 1140. When an input to the thumbnail 1145 is received, the electronic device 10 may play a trailer of the recommended movie. When an input to the application link 1140 is received, the electronic device 10 may execute an application (e.g., the T application) for reserving the recommended movie.

In an example, when an input to the application link 1140 is received, the electronic device 10 may provide a screen for reserving the movie AAA at a specific movie theater (e.g., a movie theater adjacent to the electronic device 10) at a specific time (e.g., a time after the current time). After a specified time has elapsed since provision of the recommendation UI 1130, the link (e.g., deep link) of the recommendation UI 1130 may need to be changed. For example, reservable times and/or reservable movie theaters may change as time elapses. For example, the electronic device 10 may monitor information about reservable times and movie theaters using an artificial intelligence model. When information about reservable times and/or movie theaters changes, the electronic device 10 may generate a new recommendation UI based on the changed information. As another example, when a specified time has elapsed since provision of the recommendation UI 1130 (e.g., without execution of the recommended action), the electronic device 10 may generate a new recommendation UI.

With reference to FIGS. 5 to 8, 9A to 9D, 10, and 11, examples associated with multimedia have been described. However, embodiments of the disclosure are not limited thereto. For example, the electronic device 10 may identify, as a user intent, financial operations related to remittance, deposit, and/or withdrawal. In this case, the electronic device 10 may provide a recommendation UI including information (e.g., an execution link of a banking application) for performing the financial operation.

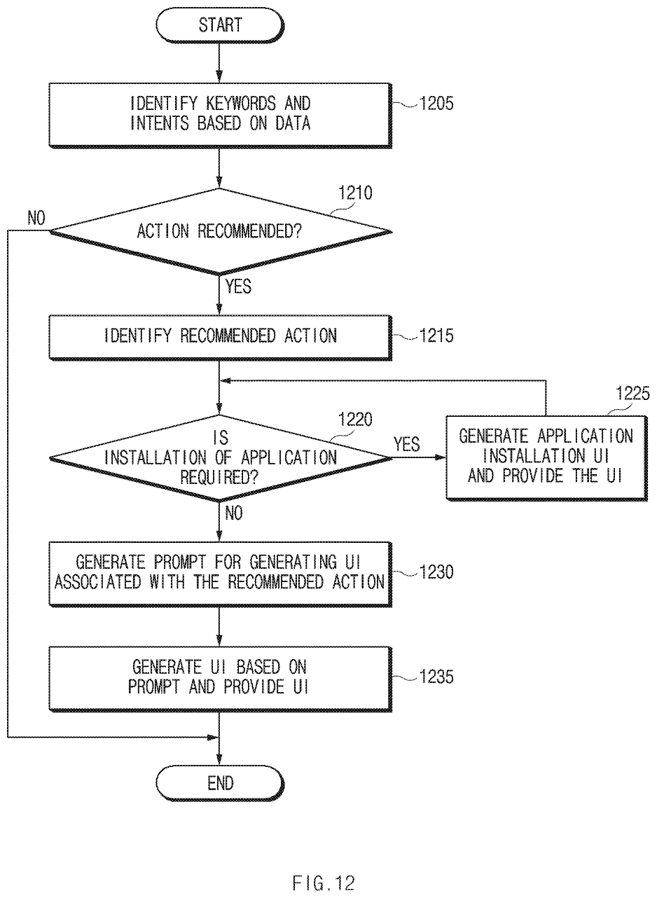

FIG. 12 is a flowchart of a method for providing a UI by an electronic device according to an embodiment of the disclosure.

Operations described below with reference to FIG. 12 may be referred to as operations of the electronic device 10 of FIG. 1. An order of the operations described below with reference to FIG. 12 is merely an example, and embodiments of the disclosure are not limited thereto. For example, at least some of the operations may be performed in an order different from that of FIG. 12 or may be performed substantially simultaneously with other operations of FIG. 12. At least some of the operations described below with reference to FIG. 12 may be omitted.

Referring to FIGS. 1 to 8 and 12, in operation 1205, the electronic device 10 may identify data-based keywords and intents. For example, the electronic device 10 may identify keywords and intents from data collected by the data management module 310 of FIG. 3. The data may be data acquired from an application currently running on the electronic device 10.

For example, the electronic device 10 may identify keywords and intents from the data using an AI model. The artificial intelligence model may include an LLM configured to extract keywords from the collected data. The electronic device 10 may identify at least one keyword from the data using the artificial intelligence model and identify an intent corresponding to the at least one keyword.

In operation 1210, the electronic device 10 may determine whether to recommend an action. The electronic device 10 may determine whether to recommend the action based on the identified keywords and/or intent. For example, the electronic device 10 may determine whether to recommend the action using the trigger management module 320 of FIG. 3. For example, when the trigger management module 320 determines generation of the recommendation UI, the electronic device 10 may determine to recommend the action. When the trigger management module 320 determines not to generate the recommendation UI, the electronic device 10 may determine not to recommend the action. When it is determined not to recommend the action (e.g., operation 1210—NO), the electronic device 10 may terminate execution of the UI providing method without performing an additional operation.

For example, when a keyword indicating a user's intent and/or willingness is identified from the identified keywords and/or intent, the electronic device 10 may affirmatively determine to recommend the action. For example, the electronic device 10 may determine whether to recommend the action according to the method described above with reference to the trigger resolver 630 related to FIG. 5.

When it is determined to recommend the action (e.g., operation 1210—YES), in operation 1215, the electronic device 10 may identify a recommended action. For example, the electronic device 10 may identify the recommended action based on the identified keywords and/or intent. The electronic device 10 may acquire additional information associated with the identified keywords and/or intent and identify the recommended action further based on the additional information. In an example, the recommended action may include generation of a recommendation UI for recommendation of a target action. The electronic device 10 may identify the recommended action according to the operation described above with reference to the data analyzer 620 of FIG. 6.

In operation 1220, the electronic device 10 may determine whether installation of an application is required. For example, the electronic device 10 may determine whether an application associated with the identified recommended action (e.g., an application required for performing a goal of the recommended action) is installed in the electronic device 10. The electronic device 10 may determine whether the application is installed based on data acquired from a database (e.g., the database 390 of FIG. 3), the OS, and/or the application. When the corresponding application is installed in the electronic device 10, the electronic device 10 may determine that installation of the application is not required. The electronic device 10 may determine whether the application is installed according to operation 805 of FIG. 8.

When installation of the application is required (e.g., operation 1220—YES), in operation 1225, the electronic device 10 may generate an application installation UI and provide the generated UI. For example, the electronic device 10 may generate and provide a UI guiding installation of the application. The electronic device 10 may generate a prompt for generating the installation UI. For example, the electronic device 10 may generate the prompt according to operation 810 of FIG. 8.

With reference to operations 1220 and 1225, provision of the UI according to whether the application is installed has been described. In an example, the electronic device 10 may determine whether a function associated with the identified recommended action (e.g., a function required for performing a goal of the recommended action) is activated. For example, the corresponding function may be in a deactivated state in the electronic device 10, or additional permission setting may be required for execution of the corresponding function. In this case, the electronic device 10 may provide a UI for activation of the corresponding function. The UI may include guide information for activation of the corresponding function. When the corresponding function is activated, the electronic device 10 may generate the prompt according to operation 1230.

When installation of the application is not required (e.g., operation 1220—NO), in operation 1230, the electronic device 10 may generate a prompt for generating a UI associated with the recommended action. The electronic device 10 may generate at least one prompt based on keywords, intent, and/or additional information. For example, the electronic device 10 may generate the prompt according to the operation described above with reference to the prompt generation module 720 of FIG. 7. As described above with reference to FIG. 7, the electronic device 10 may generate a plurality of prompts. In an example, the electronic device 10 may generate the prompt according to operation 830 or 835 of FIG. 8.

In operation 1235, the electronic device 10 may generate a UI based on the prompt and provide the UI. The electronic device 10 may generate the UI (e.g., the recommendation UI) by inputting the generated prompt into a generative AI model (e.g., the generative AI model 730 of FIG. 7). For example, the electronic device 10 may generate the UI using the UI generation module 330 of FIG. 3.

According to an embodiment, the electronic device 10 may include a rollable display (e.g., the display 160). Provision of the recommendation UI may be determined while the electronic device 10 is in a retracted state. In this case, the electronic device 10 may expand a size of a visible area of the display by rolling out the rollable display and provide the recommendation UI on the rolled-out display. In an example, the electronic device 10 may provide guide information for rolling out the display 160 in order to provide the recommendation UI.

According to an embodiment, the electronic device 10 may include a foldable display (e.g., the display 160). Provision of the recommendation UI may be determined while the electronic device 10 is in a folded state. In an example, the electronic device 10 may provide the recommendation UI when the electronic device 10 is unfolded. The electronic device 10 may provide guide information for unfolding the electronic device 10 through a display area visible from the outside in the folded state (e.g., a display separate from the foldable display or a partial area of the foldable display).

According to an embodiment, the electronic device 10 may provide the recommendation UI through an external electronic device. For example, the electronic device 10 may transmit information about the recommendation UI to the external electronic device using the communication circuitry 190. The external electronic device may provide the recommendation UI using the received information about the recommendation UI. The external electronic device may be, for example, a device configured to support continuity with the electronic device 10.

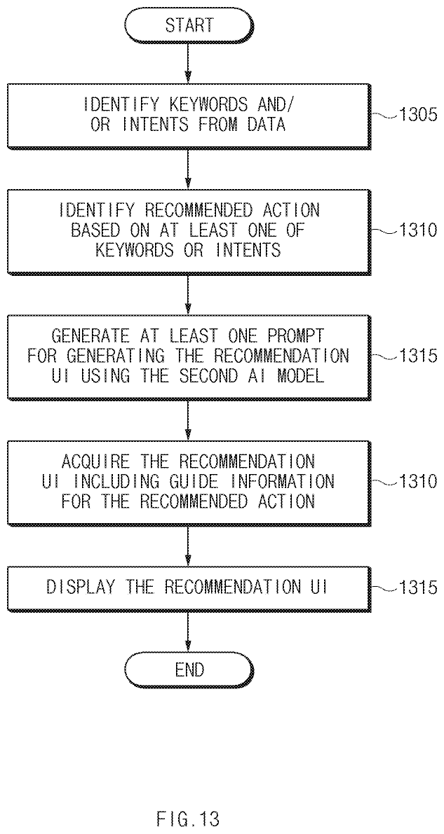

FIG. 13 is a flowchart of a method for acquiring a recommendation UI of an electronic device according to an embodiment of the disclosure.

Operations described below with reference to FIG. 13 may be referred to as operations of the electronic device 10 of FIG. 1. An order of the operations described below with reference to FIG. 13 is merely an example, and embodiments of the disclosure are not limited thereto. For example, at least some of the operations may be performed in an order different from that of FIG. 13 or may be performed substantially simultaneously with other operations of FIG. 13. At least some of the operations described below with reference to FIG. 13 may be omitted.

Referring to FIGS. 1 to 8, 9A to 9D, and 10 to 13, according to an embodiment, the electronic device 10 may include the display 160, at least one processor 120 electrically connected to the display 160, and the memory 130 electrically connected to the at least one processor 120 and storing instructions. When executed by the at least one processor 120, the instructions may cause the electronic device 10 to perform operations described below.

In operation 1305, the electronic device 10 may identify keywords and/or intents from data. For example, the electronic device 10 may identify, using a first artificial intelligence model, at least one keyword and/or at least one intent from data (e.g., an image and/or text) including at least one of messages, schedule information, or input information. The electronic device 10 may extract the keywords and/or intents from the data by inputting the data into the first artificial intelligence model (LLM). For example, the electronic device 10 may identify the keywords and/or intents according to operation 1205 of FIG. 12.

For example, the electronic device 10 may store the data as structured data in the memory 130. The electronic device 10 may store the data according to the operation of the data management module 310 of FIG. 3. The electronic device 10 may identify the keywords and/or intents by processing the structured data using the first artificial intelligence model.

In operation 1310, the electronic device 10 may identify a recommended action based on at least one of the identified keywords or intents. For example, the electronic device 10 may identify the recommended action based on the identified keywords and/or intents. The electronic device 10 may acquire additional information associated with the identified keywords and/or intents and identify the recommended action further based on the additional information. In an example, the recommended action may include generation of a recommendation UI for recommendation of a target action.

In an example, the electronic device 10 may determine whether to recommend an action based on the identified keywords. For example, the electronic device 10 may determine whether to recommend the action according to operation 1210 of FIG. 12. Based on determining to recommend the action, the electronic device 10 may identify the recommended action.

In operation 1315, the electronic device 10 may generate at least one prompt for generating the recommendation UI using a second artificial intelligence model. In an example, the second artificial intelligence model may be a generative AI model (e.g., the generative AI model 250 of FIG. 2 and/or the generative AI model 730 of FIG. 7). For example, the electronic device 10 may generate the at least one prompt by inputting information about the recommended action into the second artificial intelligence model. The electronic device 10 may generate the at least one prompt according to operation 1230 of FIG. 12.

In an example, the at least one prompt may include a first prompt and a second prompt. The first prompt may include information instructing a structure of the recommendation UI. The structure of the recommendation UI may include information about a color, size, display position, component, and/or associated operation (e.g., an intent or deep link) of the recommendation UI. The second prompt may include information instructing resources of the recommendation UI. For example, the electronic device 10 may acquire the structure of the recommendation UI by inputting the first prompt into a generative AI model (e.g., a first generative AI model). The electronic device 10 may acquire UI resources by inputting the second prompt into a generative AI model (e.g., a second generative AI model). The electronic device 10 may generate the recommendation UI by combining the UI resources with the structure of the UI.

In operation 1320, the electronic device 10 may acquire a recommendation UI including guide information for the recommended action. For example, the electronic device 10 may acquire the recommendation UI by inputting the at least one prompt into a third generative artificial intelligence model (e.g., the generative AI model 250 of FIG. 2 and/or the generative AI model 730 of FIG. 7). For example, the electronic device 10 may acquire the recommendation UI according to operation 1230 of FIG. 12. For example, the recommendation UI may include at least one of a widget, a floating window, a graphic object, an image, an icon, or schedule information.

In an example, the recommended action may be associated with a specified application or a specified function. When the specified application is not installed in the electronic device 10, the electronic device 10 may generate a recommendation UI including guide information about installation of the specified application, and when the specified function is deactivated, the recommendation UI may include guide information about activation of the specified function.

In operation 1325, the electronic device 10 may display the recommendation UI. The electronic device 10 may display the recommendation UI on the display 160. The electronic device 10 may provide the recommendation UI as a widget, an overlay image, or an in-application message. As described above with reference to FIGS. 9A to 9D, the electronic device 10 may display the recommendation UI based on context information. For example, the electronic device 10 may provide the recommendation UI after termination of display of an execution screen of a currently running application. As another example, the electronic device 10 may display the recommendation UI on an execution screen of a currently running application. The context information may include, for example, a location of the electronic device 10, and the location of the electronic device may include at least one of a home, a company, or an in-vehicle state identified based on a movement speed of the electronic device.

FIG. 14 is a block diagram illustrating an electronic device in a network environment according to an embodiment of the disclosure.

Referring to FIG. 14, an electronic device 1401 in a network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to one embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, a HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to one embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the millimeter wave (mmWave) band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 1464 dB or less) for implementing mMTC, or user plane (U-plane) latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a specified high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the specified high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or the server 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
at least one processor communicatively coupled to the display and the memory,
wherein the instructions, when executed by the at least one processor individually or collectively, cause the electronic device to:
identify, using a first artificial intelligence (AI) model, at least one of one or more keywords or one or more intents from data comprising at least one of message information, schedule information, or input information,
identify a recommended action based on at least one of the one or more keywords or the one or more intents,
generate, using a second AI model, at least one prompt to generate a recommendation user interface (UI),
acquire, by inputting the at least one prompt to a third generative AI model, the recommendation UI comprising guide information for the recommended action, and
display the recommendation UI on the display.

2. The electronic device of claim 1, wherein the instructions, when executed by the at least one processor individually or collectively, further cause the electronic device to:
acquire the one or more keywords or the one or more intents by inputting an image or a text included in the data into the first AI model.

3. The electronic device of claim 2, wherein the instructions, when executed by the at least one processor individually or collectively, further cause the electronic device to:
determine whether to recommend an action based on the one or more keywords; and
based on a determination to recommend the action, identify the recommended action.

4. The electronic device of claim 2, wherein the instructions, when executed by the at least one processor individually or collectively, further cause the electronic device to:
generate the at least one prompt by inputting information of the recommended action into the second AI model.

5. The electronic device of claim 1, wherein the instructions, when executed by the at least one processor individually or collectively, further cause the electronic device to:
store at least one of the message information, the schedule information, or the input information as structured data in the memory; and
identify at least one of the one or more keywords or the one or more intents by processing the structured data with the first AI model.

6. The electronic device of claim 1,
wherein the recommended action is associated with a specified application or a specified function,
wherein, when the specified application is not installed on the electronic device, the recommendation UI comprises guide information about installation of the specified application, and
wherein, when the specified function is deactivated, the recommendation UI comprises guide information about activation of the specified function.

7. The electronic device of claim 1, wherein the instructions, when executed by the at least one processor individually or collectively, further cause the electronic device to provide the recommendation UI as a widget, an overlay image, or an in-application message.

8. The electronic device of claim 7, wherein the instructions, when executed by the at least one processor individually or collectively, further cause the electronic device to, based on context information:
provide the recommendation UI after termination of display of an execution screen of a currently running application; or
provide the recommendation UI on the execution screen of the currently running application.

9. The electronic device of claim 8,
wherein the context information comprises a location of the electronic device, and
wherein the location comprises at least one of a home, a workplace, or an in-vehicle state identified from a movement speed of the electronic device.

10. The electronic device of claim 1, wherein the recommendation UI comprises at least one of a widget, a floating window, a graphic object, an image, an icon, a message, or a schedule.

11. A method for providing a recommendation user interface (UI) by an electronic device, the method comprising:
identifying, using a first artificial intelligence (AI) model, at least one of one or more keywords or one or more intents from data comprising at least one of message information, schedule information, or input information;
identifying a recommended action based on at least one of the one or more keywords or the one or more intents;
generating, using a second AI model, at least one prompt to generate the recommendation UI;
acquiring, by inputting the at least one prompt to a third generative AI model, the recommendation UI comprising guide information for the recommended action; and
displaying the recommendation UI.

12. The method of claim 11, wherein the identifying at least one of one or more keywords or one or more intents comprises:
acquiring the one or more keywords or the one or more intents by inputting an image or a text included in the data into the first AI model.

13. The method of claim 12, further comprising:
determining whether to recommend an action based on the one or more keywords,
wherein the identifying the recommended action is performed based on a determination to recommend the action.

14. The method of claim 12, wherein the generating the at least one prompt comprises generating the at least one prompt by inputting information of the recommended action into the second AI model.

15. The method of claim 11, further comprising:
storing at least one of the message information, the schedule information, or the input information as structured data,
wherein the identifying at least one of one or more keywords or one or more intents comprises identifying at least one of the one or more keywords or the one or more intents by processing the structured data with the first AI model.

16. One or more non-transitory computer-readable storage media storing one or more computer programs including computer-executable instructions that, when executed by one or more processors of an electronic device individually or collectively, cause the electronic device to perform operations, the operations comprising:
identifying, using a first artificial intelligence (AI) model, at least one of one or more keywords or one or more intents from data comprising at least one of message information, schedule information, or input information;
identifying a recommended action based on at least one of the one or more keywords or the one or more intents;
generating, using a second AI model, at least one prompt to generate a recommendation user interface (UI);
acquiring, by inputting the at least one prompt to a third generative AI model, the recommendation UI comprising guide information for the recommended action; and
displaying the recommendation UI.

17. The one or more non-transitory computer-readable storage media of claim 16, wherein the identifying at least one of one or more keywords or one or more intents comprises:
acquiring the one or more keywords or the one or more intents by inputting an image or a text included in the data into the first AI model.

18. The one or more non-transitory computer-readable storage media of claim 17, the operations further comprising:
determining whether to recommend an action based on the one or more keywords,
wherein the identifying the recommended action is performed based on a determination to recommend the action.

19. The one or more non-transitory computer-readable storage media of claim 17, wherein the generating the at least one prompt comprises generating the at least one prompt by inputting information of the recommended action into the second AI model.

20. The one or more non-transitory computer-readable storage media of claim 16, the operations further comprising:
storing at least one of the message information, the schedule information, or the input information as structured data,
wherein the identifying at least one of one or more keywords or one or more intents comprises identifying at least one of the one or more keywords or the one or more intents by processing the structured data with the first AI model.
